(19) United States
(12) Patent Application Publication
(10) Pub. No.: US 2026/0198587 A1
(43) Pub. Date: Jul. 16, 2026

(54) FLAVOR INHALER AND METHOD FOR MANUFACTURING FLAVOR INHALER

(71) Applicant: Japan Tobacco Inc., Tokyo (JP)

(72) Inventors: Ikuo FUJINAGA, Tokyo (JP); Yasunobu INOUE, Tokyo (JP)

(73) Assignee: Japan Tobacco Inc., Tokyo (JP)

(21) Appl. No.: 19/135,080

(22) PCT Filed: Dec. 16, 2022
(86) PCT No.: PCT/JP2022/046320

§ 371 Date: Jun. 3, 2025

(51) Int. Cl. A24F 40/465; A24F 40/20; A24F 40/51; A24F 40/70; H05B 3/42

(52) U.S. Cl. CPC A24F 40/465; A24F 40/20; A24F 40/51; A24F 40/70; H05B 3/42

(57) ABSTRACT

Provided is a flavor inhaler. This flavor inhaler comprises: a cylindrical accommodation part that accommodates a consumable material; a heating part that heats the consumable material accommodated in the accommodation part; a first heat insulation part that is positioned so as to cover at least a portion of the accommodation part and inhibits the release of heat outside the accommodation part; and a housing that accommodates the accommodation part, the heating part, and the first heat insulation part. The first heat insulation part has a multilayer structure in which a heat-resistant sheet-like heat insulation member is wrapped around the periphery of a cylindrical portion of the accommodation part in multiple layers. The innermost surface of the first heat insulation part is in contact with the accommodation part and/or the heating part, and the outermost surface of the first heat insulation part is isolated from the inner surface of the housing.

### TECHNICAL FIELD

The present invention relates to a flavor inhaler and a method for manufacturing a flavor inhaler.

### BACKGROUND ART

Flavor inhalers for inhalation of flavors and the like, without combustion of materials, are conventionally known. Such flavor inhalers are known to comprise a first heat insulation part arranged around the outer circumference of a heating part for heating a smokable substance, and an external heat insulation part arranged around the outer circumference of the first heat insulation part but separate from the first heat insulation part (see, for example, PTL 1).

### CITATION LIST

### Patent Literature

[PTL 1] WO 2021/214924 A1

### SUMMARY OF INVENTION

### Technical Problem

In flavor inhalers, both miniaturization of an atomization unit, which includes a heating part and a heat insulation part, and a thermal insulating function are required. In the flavor inhaler disclosed in PTL 1, the first heat insulation part is arranged around the outer circumference of the heating part, and an external heat insulation part is arranged around the outer circumference of the first heat insulation part but separated from the first heat insulation part. The diameter of the atomization unit may therefore increase. Also, in the flavor inhaler disclosed in the PTL 1, making the heat insulation part thinner reduces the insulating function.

The present invention has been made to solve at least part of the above-mentioned problems, and aims to simultaneously reduce the size of the atomization unit and provide a thermal insulation function.

### Solution to Problem

In a first aspect of the present invention, a flavor inhaler is provided. The flavor inhaler comprises: a cylindrical accommodation part that accommodates a consumable material; a heating part for heating the consumable material accommodated in the accommodation part; a first heat insulation part arranged to cover at least a portion of the accommodation part to reduce heat dissipation to the outside of the accommodation part; and a housing that accommodates the accommodation part, the heating part, and the first heat insulation part, wherein the first heat insulation part has a multi-layer structure in which a heat-resistant sheet-like insulation member is wound in multiple layers around the cylindrical portion of the accommodation part, an innermost surface of the first heat insulation part is in contact with the accommodation part and/or the heating part, and an outermost surface of the first heat insulation part is separated from the inner surface of the housing.

According to a first aspect of the invention, the first heat insulation part has a structure in which a heat-resistant sheet-like insulation member is wound around the cylindrical portion of the accommodation part, wherein the innermost surface of the first heat insulation part is in contact with the accommodation part and/or the heating part. Therefore, the heat insulation part can be arranged in direct contact with the accommodation part and/or the heating part while exhibiting the heat insulation function, so it is possible to simultaneously reduce the size of the atomization unit having the heating part and the heat insulation part and provide a thermal insulation function. Also, the first heat insulation part has a multi-layer structure in which a heat-resistant sheet-like insulation member is wound in multiple layers around the cylindrical portion of the accommodation part, so the thermal insulation function of the atomization unit can be improved more than if the heat insulation part is a single layer. Also, the outermost surface of the first heat insulation part is separated from the inner surface of the housing, so it is possible to reduce the temperature of the surface of the housing. Furthermore, the first heat insulation part on its own can reduce heat dissipation from the accommodation part to the outside, so the number of components can be reduced compared with the case with a plurality of heat insulation parts.

In a second aspect of the invention, the first heat insulation part in the first aspect comprises one sheet-like insulation member.

According to a second aspect of the invention, by continuously wrapping one sheet-like insulation member around the cylindrical portion of the accommodation part, the first heat insulation part having a multi-layer structure can be easily configured.

In a third aspect of the invention, in the first or second aspect, the thickness of the sheet-like insulation member is one mm or less.

According to a third aspect of the invention, by making the thickness of the sheet-like insulation member 1 mm or less, the sheet-like insulation member becomes easier to bend, so it is possible to reduce the formation of gaps between the accommodation part and the sheet-like insulation member, and between each layer of the sheet-like insulation member, in the first heat insulation part.

In a fourth aspect of the invention, in any of the first to third aspects, the first insulating portion has a multi-layer structure in which the sheet-like insulation member is wound in three to seven layers.

According to a fourth aspect of the invention, the first heat insulation part has a multi-layer structure in which the sheet-like insulation member is wound in three to seven layers, thereby reducing the size of the atomization unit and providing a thermal insulation function, and also reducing the outermost surface temperature of the first heat insulation part so it can be lowered to a temperature that does not affect the surrounding member (for example, about 200° C. or less).

In a fifth aspect of the invention, in any of the first to fourth aspects, the first heat insulation part comprises a radiation suppression material.

According to a fifth aspect of the invention, a thermal insulation function of the atomization unit can be improved because the first heat insulation part includes the radiation suppression material, which can reduce thermal radiation to the outside of the accommodation part.

In a sixth aspect of the invention, in the fifth aspect, the radiation suppression material is sheet-like and arranged between layers of the first heat insulation part.

According to a sixth aspect of the invention, by arranging the sheet-like radiation suppression material between the layers of the first heat insulation part, thermal radiation to the outside of the accommodation part can be reduced, thereby improving the thermal insulation function of the atomization unit.

In a seventh aspect of the invention, in the sixth aspect, the radiation suppression material is arranged on an outer surface of the innermost layer of the first heat insulation part.

According to a seventh aspect of the invention, by arranging the sheet-like radiation suppression material on the outer surface of the innermost layer of the first heat insulation part, that is at a position close to the accommodation part, thermal radiation to the outside of the accommodation part can be efficiently reduced.

In an eighth aspect of the invention, any one of the first to seventh aspects further comprises a heat diffusion member arranged between layers of the first heat insulation part and extending in the longitudinal direction of the flavor inhaler.

According to an eighth aspect of the invention, by arranging the heat diffusion members extending along the longitudinal direction of the flavor inhaler between the layers of the first heat insulation part, the heat diffusion members diffuse heat in the longitudinal direction of the flavor inhaler, which can prevent local high temperatures in the first heat insulation part.

In a ninth aspect of the invention, any one of the first to eighth aspects further comprises sealing portions covering both ends of the first heat insulation part in the longitudinal direction of the flavor inhaler.

According to a ninth aspect of the invention, by arranging the sealing portions covering both ends of the first heat insulation part in the longitudinal direction of the flavor inhaler, it is possible to reduce the ingress of air into the first heat insulation part to reduce convection of air and prevent the sheet-like insulation member from falling out, and degradation of the thermal insulation function of the atomization unit can be inhibited.

In a tenth aspect of the invention, the ninth aspect further comprises a fixing part securing the first heat insulation part and the sealing portions.

According to a tenth aspect of the invention, by securing the first heat insulation part and the sealing portions with the fixing part, the ingress of moisture into the first heat insulation part can be reduced. Therefore, it is possible to prevent the energy of the heating part from being used to heat the moisture entering the first heat insulation part. Also, by securing the first heat insulation part and the sealing portions with the fixing part, the sheet-like insulation member and the sealing portions can be prevented from falling out, and the generation of abnormal noise can be prevented as movement of the first heat insulation part within the housing is eliminated.

In an eleventh aspect of the invention, in any one of the first to tenth aspects, the first heat insulation part has a major diameter and a minor diameter in a cross section perpendicular to the longitudinal direction of the flavor inhaler, and further comprises a control unit arranged adjacent to the accommodation part in the direction of the minor diameter.

According to an eleventh aspect of the invention, arranging the control unit adjacent to the accommodation part in the direction of the minor diameter of the first heat insulation part allows the size of the flavor inhaler to be reduced as the control unit can be arranged closer to the accommodation part than arranging the control unit adjacent to the accommodation part in the direction of the major diameter of the first heat insulation part.

In a twelfth aspect of the invention, any one of the first to eleventh aspects further comprises a sensor for measuring the temperature of the accommodation part arranged between layers of the first heat insulation part.

According to the twelfth aspect of the invention, by arranging the sensor for measuring the temperature of the accommodation part between layers of the first heat insulation part, the sensor can be used in a temperature range in accordance with the heat-resistance temperature of the sensor. Also, by positioning the sensor between the layers of the first heat insulation part rather than exposing it to the outermost surface of the first heat insulation part, it is possible to absorb the positioning tolerance of the sensor as the temperature distribution is averaged with respect to the longitudinal direction of the flavor inhaler.

In a thirteenth aspect of the invention, any one of the first to twelfth aspects further comprises a second heat insulation part having less heat resistance and more thermal insulation than the first heat insulation part, arranged on an outer circumference of the first heat insulation part.

According to the thirteenth aspect of the invention, by arranging, as the second heat insulation part on an outer circumference of the first heat insulation part, a material that is less heat resistant and cannot be placed in direct contact with the accommodation part and/or the heating part but that is more thermally insulating than the sheet-like insulation member that constitutes the first heat insulation part, the thermal insulation function of the atomization unit can be improved.

In a fourteenth aspect of the invention a method of manufacturing a flavor inhaler is provided. This method of manufacturing the flavor inhaler comprises a step of preparing a cylindrical accommodation part for accommodating the consumable material, and a step of wrapping one heat-resistant sheet-like insulation member in multiple layers around the cylindrical portion of the accommodation part.

According to the fourteenth aspect of the invention, by continuously wrapping one sheet-like insulation member around the cylindrical portion of the accommodation part, a heat insulation part having a multi-layer structure can be easily configured. Furthermore, the flavor inhaler manufactured by this manufacturing method has the heat insulation part having the heat-resistant sheet-like insulation member wrapped around the cylindrical portion of the accommodation part, so it is possible to simultaneously reduce the size of the atomization unit having the heating part that heats the consumable material accommodated in the accommodation part and the heat insulation part and provide a thermal insulation function. Furthermore, the heat insulation part has a multi-layer structure in which a heat-resistant sheet-like insulation member is wrapped in multiple layers around the cylindrical portion of the accommodation part, so the thermal insulation function of the atomization unit can be improved more than if the heat insulation part is a single layer.

In a fifteenth aspect of the invention, in the fourteenth aspect, the thickness of the sheet-like insulation member is one mm or less.

According to the fifteenth aspect of the invention, by making the thickness of the sheet-like insulation member one mm or less, the sheet-like insulation member becomes easier to bend, thereby preventing gaps from forming in the heat insulation part between the accommodation part and the sheet-like insulation member, and between each layer of the sheet-like insulation member.

### BRIEF DESCRIPTION OF DRAWINGS

FIG. 1 is an oblique view showing a flavor inhaler according to an embodiment of the present invention;

FIG. 2 is an oblique view of a flavor inhaler containing consumable material;

FIG. 3 is a cross-sectional view showing a flavor inhaler along the arrows 3-3 in

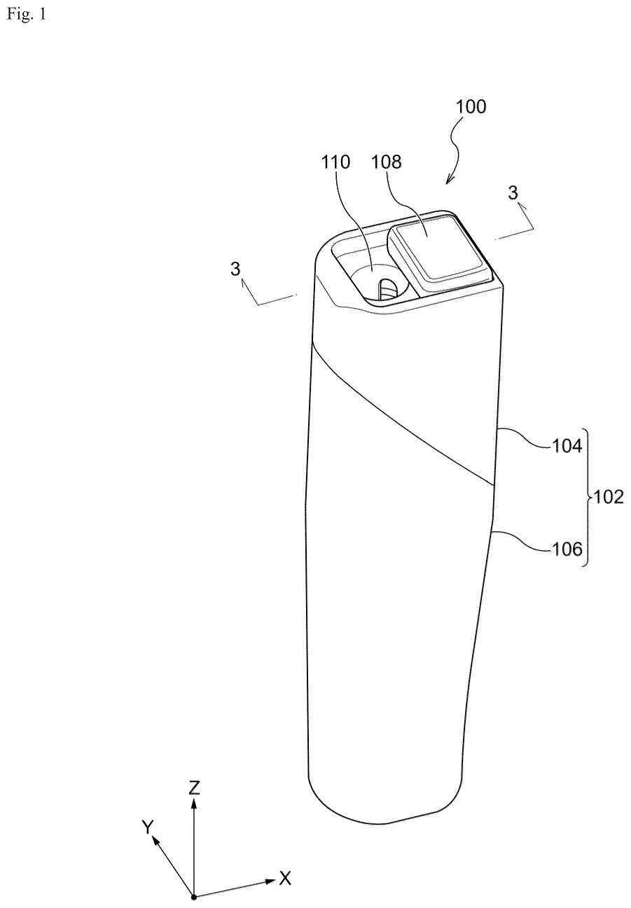

FIG. 1;

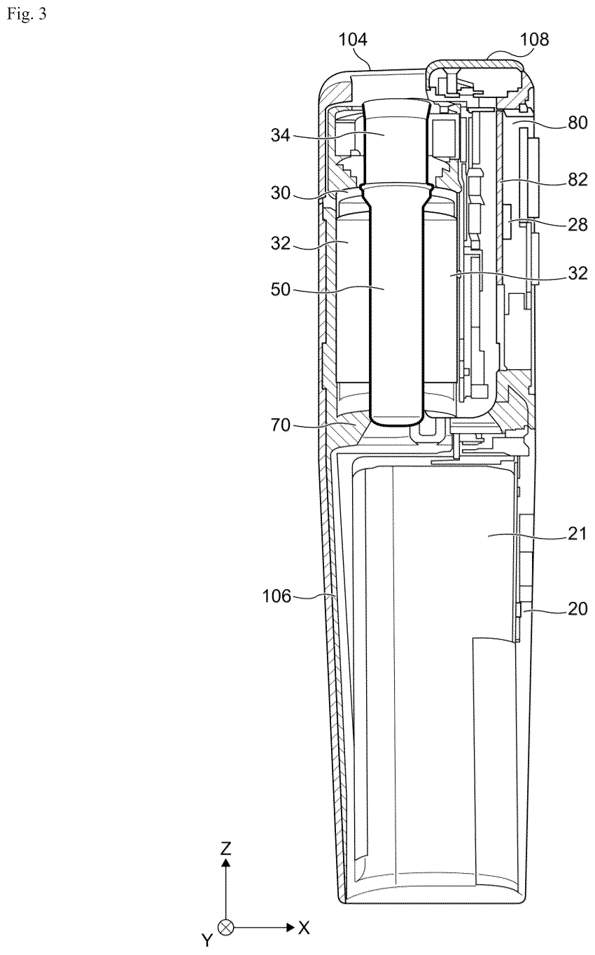

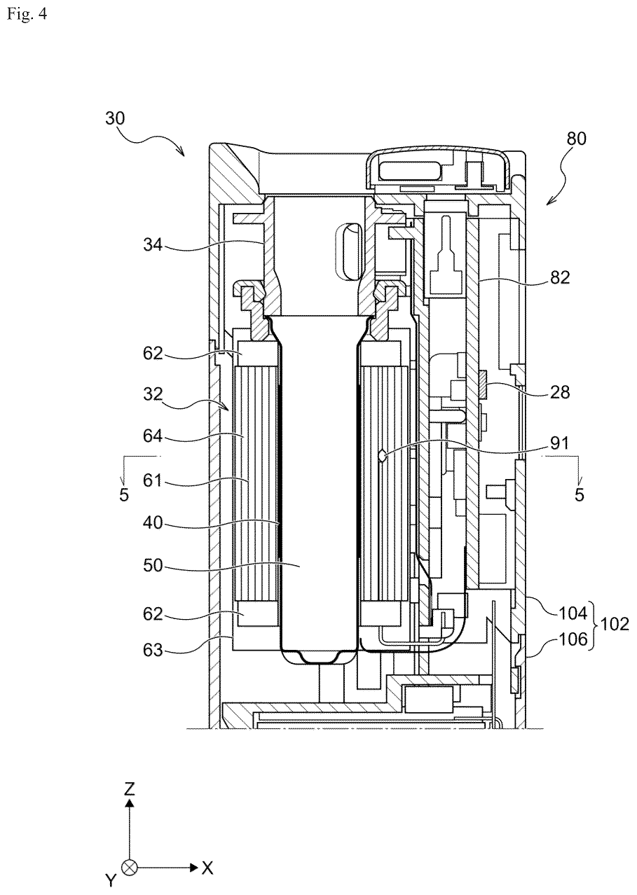

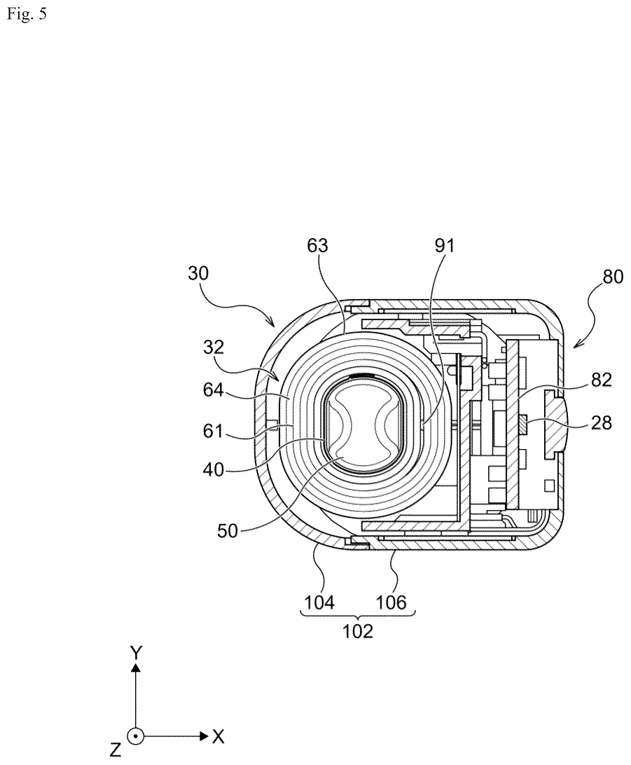

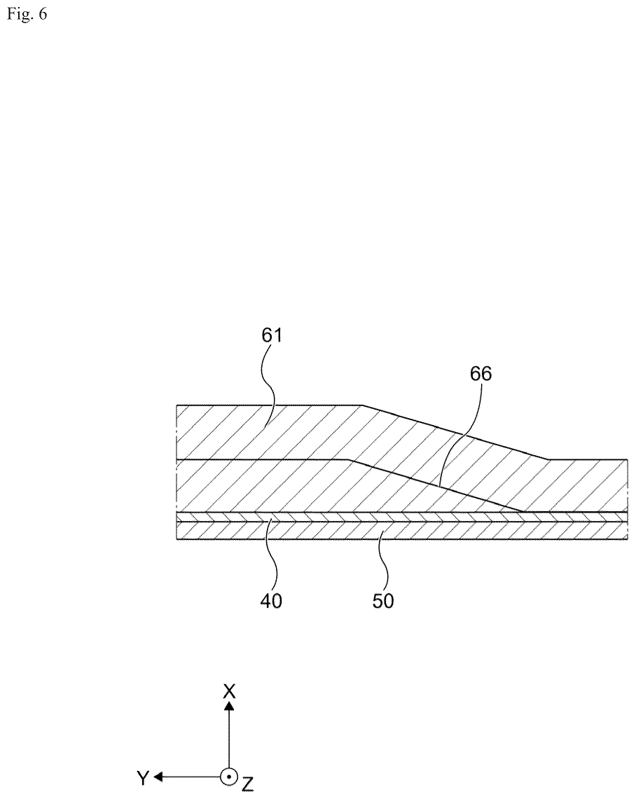

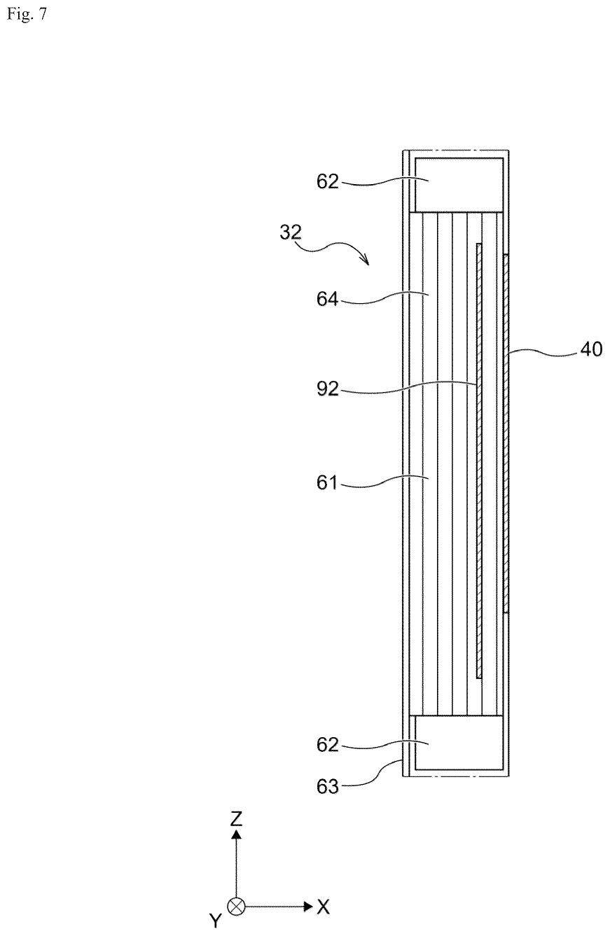

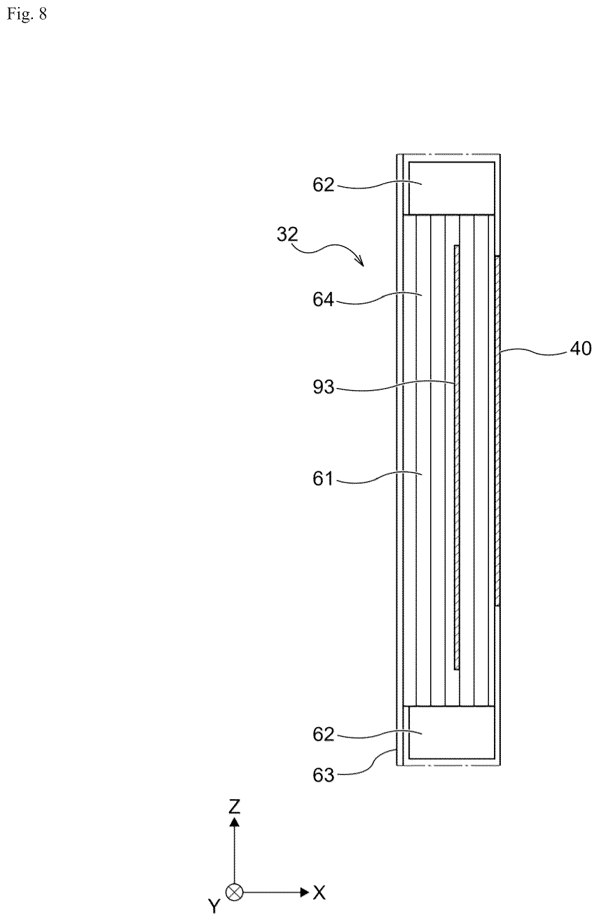

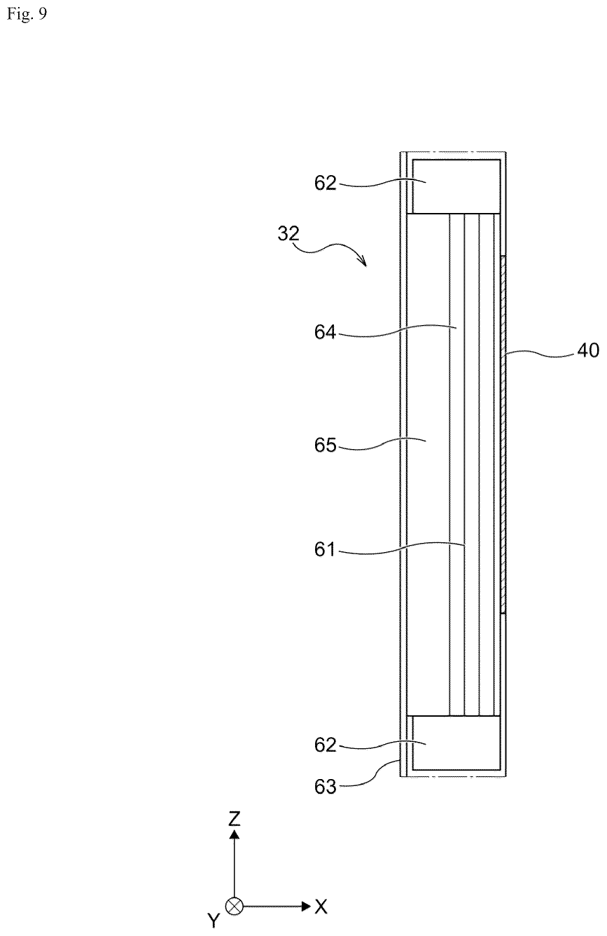

FIG. 4 is an enlarged cross-sectional view of the atomization unit and the control unit shown in FIG. 3;

FIG. 5 is a cross-sectional view showing a flavor inhaler along the arrows 5-5 in

FIG. 4;

FIG. 6 is an enlarged cross-sectional view showing a portion extracted from FIG. 5;

FIG. 7 is an enlarged cross-sectional view showing a portion of the heat insulation part in FIG. 4;

FIG. 8 is an enlarged cross-sectional view showing a portion of the heat insulation part in FIG. 4; and

FIG. 9 is an enlarged cross-sectional view showing a portion of the heat insulation part in FIG. 4.

### DESCRIPTION OF EMBODIMENTS

Embodiments of the present invention are described below with reference to the drawings. In the drawings described below, the same or corresponding components are indicated by the same symbols, and will not be described more than once.

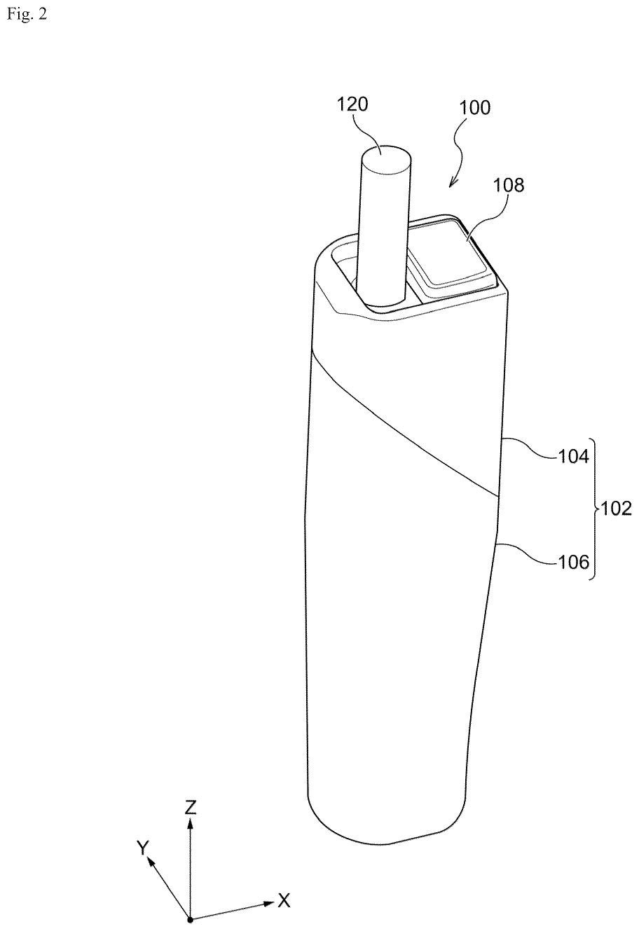

FIG. 1 is an oblique view showing a flavor inhaler 100 according to an embodiment of the present invention. FIG. 2 is an oblique view of the flavor inhaler 100 containing consumable material 120 inserted through an aperture 110. An X-Y-Z orthogonal coordinate system may be applied to the drawings described in the present specification for convenience of description. In this coordinate system, the Z-axis is oriented vertically upwards, the X-Y plane is arranged cutting across the flavor inhaler 100 in a horizontal direction, and the Y-axis is arranged extending from the front surface to the rear surface of the flavor inhaler 100. The Z-axis direction may also refer to the direction of insertion of the consumable material 120 that is accommodated in a chamber 50 to be described later. The X-axis direction can also refer to a device long side direction in a plane perpendicular to the insertion direction of the consumable material 120. The Y-axis direction can also refer to a device short side direction in a plane perpendicular to the insertion direction of the consumable material 120.

The flavor inhaler 100 according to the present embodiment is, for example, configured to generate an aerosol containing a flavor by heating a stick-type consumable material 120 having a flavor source containing an aerosol source. As an example, the consumable material 120 includes, on a tip end side in the Z-axis negative direction, a smokable substance that contains a flavor source such as tobacco and an aerosol source, and also includes a filter on another part. Aerosol sources that may be cited include, for example, glycerol, propylene glycol, triacetin, 1,3-butanediol, and mixtures thereof. It should be noted that, in the embodiment, the consumable material 120 is described as being stick-shaped, but the consumable material used in the flavor inhaler 100 is not limited to this shape. For example, the consumable material can also be configured to include a cartridge accommodating a liquid aerosol source. Also, this cartridge may include a heating part.

As shown in FIGS. 1 and 2, the flavor inhaler 100 comprises: a housing 102 formed from an upper housing 104 and a lower housing 106; and a sliding cover 108. The housing 102 forms the outermost housing of the flavor inhaler 100, and is of a size that fits in the user's hand. When the user is using the flavor inhaler 100, the user can inhale the aerosol while holding the flavor inhaler 100 in their hand.

It should be noted for the housing 102 in this case that the upper housing 104 is formed from a resin such as polycarbonate, for example, and the lower housing 106 is formed from a metal such as aluminum, for example. However, the housing 102 is not limited to the materials above and may also be made of a resin, for example, and it is possible to select any suitable material, such as, in particular, polycarbonate (PC), acrylonitrile-butadiene-styrene (ABS) resin, polyether ether ketone (PEEK), or a polymer alloy containing multiple types of polymers.

The upper housing 104 includes the aperture 110 for receiving the consumable material 120, and a sliding cover 108 that is slidably attached to the upper housing 104 so as to close the aperture 110. Specifically, the sliding cover 108 is configured to be movable along an outer surface of the upper housing 104 between a closed position for closing the aperture 110 of the upper housing 104, and an open position (the position shown in FIGS. 1 and 2) for opening the aperture 110. For example, the user can manually operate the sliding cover 108 to move the sliding cover 108 between the closed position and the open position. As a result, the sliding cover 108 can permit or restrict access of the consumable material 120 to the inside of the flavor inhaler 100.

Here, FIGS. 1 and 2 show a housing 102 of the flavor inhaler 100 in such a way that mating surfaces of the upper housing 104 and the lower housing 106 obliquely intersect the X-Y plane, but the housing 102 is not limited to such a configuration. For example, the housing 102 may also be formed from three or more members.

The flavor inhaler 100 may further include a terminal, which is not shown in the drawings. The terminal may be an interface for connecting the flavor inhaler 100 to an external power source, for example. When the power source of the flavor inhaler 100 is a rechargeable battery, the external power source can be connected to the terminal so that a current is supplied from the external power source to the power source, and the power source can be charged. Furthermore, data relating to operation of the flavor inhaler 100 may also be sent to an external device by connecting a data transmission cable to the terminal.

Next, the internal structure of the flavor inhaler 100 according to an embodiment of the present invention is described. FIG. 3 is a cross-sectional view of the flavor inhaler 100 in the direction of the arrows 3-3 shown in FIG. 1. As shown in FIG. 3, a power source unit 20, an atomization unit 30, and a control unit 80 are provided in an internal space of the housing 102 of the flavor inhaler 100.

The control unit 80 includes a board 82. The board 82 may include a microprocessor, etc., for example, and can control the supply of power from the power source unit 20 to the atomization unit 30. This enables the control unit 80 to control heating of the consumable material 120 by the atomization unit 30. Furthermore, the control unit 80 includes a Bluetooth (registered trademark) interface 28. The control unit 80 can communicate with an external device via the Bluetooth (registered trademark) interface 28.

The power source unit 20 comprises a power source 21 that is electrically connected to the board 82 of the control unit 80. The power source 21 may be a rechargeable battery or a non-rechargeable battery, for example. The power source 21 is electrically connected to the atomization unit 30 via the board 82. This allows the power source 21 to supply power to the atomization unit 30 to heat the consumable material 120 appropriately.

The atomization unit 30 comprises: the chamber 50 (accommodation part) extending in the longitudinal direction of the consumable material 120; a heating part not shown on the drawings, surrounding a part of the chamber 50; a heat insulation part 32; and a substantially cylindrical insertion guide member 34. The chamber 50 is configured to accommodate the consumable material 120. The heating part is configured to contact an outer circumferential surface of the chamber 50 so as to heat the consumable material 120 accommodated in the chamber 50. Note that, as an example, a susceptor can be provided inside or in close proximity to the consumable material 120, and the heating part includes an induction coil for inductively heating the susceptor.

The heat insulation part 32 is arranged to surround the chamber 50 and the heating part. The heat insulation part 32 may be an aerogel, for example. The insertion guide member 34 is formed from a resin material such as PEEK, PC or ABS, for example, and is provided between the sliding cover 108 in the closed position and the chamber 50. The insertion guide member 34 communicates with the outside of the flavor inhaler 100 when the sliding cover 108 is in the open position, and guides the insertion of the consumable material 120 into the chamber 50 when the consumable material 120 is inserted into the insertion guide member 34.

Also, the atomization unit 30 and the control unit 80 are covered by a heat diffusion sleeve 70 and arranged in the interior space of the housing 102. The heat diffusion sleeve 70 is made from a material with a high thermal conductivity, such as a metal, to diffuse heat generated in the atomization unit 30 inside the housing 102. The heat diffusion sleeve 70 can be configured to not interfere with the lower housing 106 and to be arranged inside the upper housing 104 only. Also, an open region can also be provided in the heat diffusion sleeve 70 so as not to interfere with communication with an external device by the Bluetooth (registered trademark) interface 28 of the control unit 80. Although metallic members generally interfere with electromagnetic waves, the control unit 80 is able to carry out communication with an external device via the Bluetooth (registered trademark) interface 28, at least through the open region of the heat diffusion sleeve 70.

Next, a characteristic structure of the flavor inhaler 100 according to an embodiment of the invention is described. FIG. 4 is an enlarged cross-sectional view of the atomization unit 30 and the control unit 80 shown in FIG. 3. FIG. 5 is a cross-sectional view of the flavor inhaler 100 in the direction of the arrows 5-5 shown in FIG. 4.

As shown in FIGS. 4 and 5, the atomization unit 30 includes the chamber 50, a heating part 40, a first heat insulation part 61 that constitutes the heat insulation part 32, sealing portions 62, a fixing portion 63, a sensor 91, and the insertion guide member 34. As noted above, the atomization unit 30 is accommodated in the housing 102.

The chamber 50 has a cylindrical shape for accommodating the consumable material 120. It should be noted that the chamber 50 may also have a so-called elliptical shape with a major diameter and a minor diameter in a cross section perpendicular to the longitudinal direction of the flavor inhaler 100. The chamber 50 is preferably formed from a heat-resistant material with a low coefficient of thermal expansion, and may, for example, be formed from a metal such as stainless steel, a resin such as PEEK, glass, ceramic, and so on.

The heating part 40 may be a sheet-shaped heater that heats the consumable material 120 accommodated in the chamber 50 at about 300° C., for example. The heating part 40 may be provided so as to contact the outer circumferential surface of the chamber 50, or may be provided on an inner face of the chamber 50. Note that, as described above, the heating part may be an induction coil that inductively heats a susceptor provided inside the consumable material 120 or the like.

The first heat insulation part 61 is disposed surrounding at least a portion of the chamber 50, and suppresses dissipation of heat to the outside of the chamber 50. The first heat insulation part 61 has a multi-layer structure in which a heat-resistant sheet-like insulation member 64 is wound in multiple layers around the cylindrical portion of the chamber 50. Here, the sheet-like insulation member 64 is a fibreglass sheet that includes aerogel particles, for example coated and dried on the fibreglass sheet with aerogel ink, having a heat resistance temperature of about 350° C. and a thermal conductivity of about 25 mW/mK.

The aerogel inhibits heat conduction because the internal pores are partitioned into spaces smaller than the mean free path of air (about 70 nm), so air convection is not possible. It should be noted that the mean pore size is preferably about 50 nm or less. Also, the aerogel has a low density which reduces thermal conduction. In other words, the aerogel provides high thermal insulation due to the structure described above. Note that the aerogel may be, for example, silica aerogel, carbon aerogel, a porous structure of fumed silica, or the like.

Here, the innermost surface of the first heat insulation part 61 is in contact with the chamber 50 and/or the heating part 40, and the outermost surface of the first heat insulation part 61 is separated from the inner surface of the housing 102. Also, the first heat insulation part 61 has a multi-layer structure in which one sheet-like insulation member 64 having a thickness of one mm or less, for example 0.5 mm, is wound continuously in six layers around the cylindrical portion of the chamber 50.

In other words, the first heat insulation part 61 is configured by first bringing one end of the sheet-like insulation member 64 into contact with the outer circumferential surface of the prepared chamber 50 and/or the heating part 40, and then continuously wrapping the sheet-like insulation member 64 around the cylindrical portion of the chamber 50 until six layers are formed. Here, the first heat insulation part 61 may have a multi-layer structure in which the sheet-like insulation member 64 is wound, for example, in 3 to 7 layers.

It should be noted that the first heat insulation part 61 may also have a so-called elliptical shape with a major diameter and a minor diameter in a cross section perpendicular to the longitudinal direction of the flavor inhaler 100, in accordance with the cross-sectional shape of the chamber 50. In this embodiment, the board 82 of the control unit 80 described above is arranged adjacent to the chamber 50 in the minor radial direction of the first heat insulation part 61.

The sealing portions 62 are arranged to cover both ends of the first heat insulation part 61 in the longitudinal direction of the flavor inhaler 100. The sealing portions 62 reduce the ingress of air into the first heat insulation part 61. The sealing portions 62 may, for example, be a sponge washer formed from a foam having a closed-cell structure that does not allow air to pass through.

The fixing portion 63 is arranged to cover the first heat insulation part 61 and the sealing portions 62, and secures the first heat insulation part 61 and the sealing portions 62. The fixing portion 63 may be a resin film, for example a heat shrink tube or a polyimide (PI) film. The fixing portion 63 presses and fixes the first heat insulation part 61 and the sealing portions 62 against the chamber 50.

The sensor 91 is arranged between the layers of the first heat insulation part 61, and measures the temperature of the chamber 50. The sensor 91 may be a thermistor or thermocouple temperature sensor. The temperature of the chamber 50 measured by the sensor 91 is output to the control unit 80 in order to control heating of the consumable material 120 by the atomization unit 30.

In this way, the first heat insulation part 61 has a structure in which the heat-resistant sheet-like insulation member 64 is wound around the cylindrical portion of the chamber 50, and the innermost surface of the first heat insulation part 61 is in contact with the chamber 50 and/or the heating part 40. Therefore, the first heat insulation part 61 can be arranged in direct contact with the chamber 50 and/or the heating part 40 while providing a thermal insulation function, so that it is possible to simultaneously reduce the size of the atomization unit 30 that has the heating part 40 and the first heat insulation part 61 and provide a thermal insulation function.

Also, the first heat insulation part 61 has a multi-layer structure in which the heat-resistant sheet-like insulation member 64 is wound in multiple layers around the cylindrical portion of the chamber 50, so the thermal insulation function of the atomization unit 30 can be improved more than if the insulating portion is a single-layer. Also, the outermost surface of the first heat insulation part 61 is separated from the inner surface of the housing 102, so it is possible to prevent the surface of the housing 102 from becoming hot. In addition, heat dissipation to the outside of the chamber 50 can be reduced with only the first heat insulation part 61, so the number of parts can be reduced compared with cases with a plurality of insulating portions.

Also, by continuously wrapping one sheet-like insulation member 64 around the cylindrical portion of the chamber 50, the first heat insulation part 61 with a multi-layer structure can be easily configured. In addition, by making the thickness of the sheet-like insulation member 64 one mm or less, the sheet-like insulation member 64 becomes easier to bend, so it is possible to reduce the formation of gaps between the chamber 50 and the sheet-like insulation member 64, and between each layer of the sheet-like insulation member 64, in the first heat insulation part 61.

It should be noted that the beginning end of the sheet-like insulation member 64 may be processed to be bevelled when viewed from the lateral direction. FIG. 6 is an enlarged cross-sectional view of a portion extracted from FIG. 5. As shown in FIG. 6, the beginning end of the sheet-like insulation member 64 has a bevelled portion 66 processed with an incline. This can structurally prevent the creation of voids in the first heat insulation part 61 between the outer surface of the inner wound layer and the inner surface of the outer wound layer.

Also, the first heat insulation part 61 has a multi-layer structure in which the sheet-like insulation member 64 is wound in 3 to 7 layers, thereby reducing the size of the atomization unit 30 and providing a thermal insulation function, and reducing the outermost surface temperature of the first heat insulation part 61 so it can be lowered to a temperature that does not affect the surrounding member (e.g. about 200° C. or less).

In addition, by arranging the control unit 80 adjacent to the chamber 50 in the direction of the minor axis of the first heat insulation part 61, it is possible to arrange the control unit 80 closer to the chamber 50 than if the control unit 80 was arranged adjacent to the chamber 50 in the direction of the major axis of the first heat insulation part 61, so it is possible to reduce the size of the flavor inhaler 100.

In addition, by arranging the sealing portions 62 covering both ends of the first heat insulation part 61 in the longitudinal direction of the flavor inhaler 100, it is possible to reduce ingress of air into the first heat insulation part 61 and thereby reduce air convection, and also to prevent the sheet-like insulation member 64 from falling out, thereby preventing reduction of the insulating function of the atomization unit 30.

The ingress of moisture into the first heat insulation part 61 can be reduced by securing the first heat insulation part 61 and the sealing portions 62 with the fixing portion 63. Therefore, the energy of the heating part 40 used to heat the moisture entering the first heat insulation part 61 can be reduced. Also, by securing the first heat insulation part 61 and the sealing portions 62 with the fixing portion 63, the sheet-like insulation member 64 and the sealing portions 62 can be prevented from falling out, and also movement of the first heat insulation part 61 within the housing 102 is eliminated so generation of abnormal noises can be prevented.

Also, by arranging the sensor 91, which measures the temperature of the chamber 50, between the layers of the first heat insulation part 61, the sensor 91 can be used in a temperature range that matches the heat-resistance temperature of the sensor 91. Also, by arranging the sensor 91 between the layers of the first heat insulation part 61 without exposing the outermost surface of the first heat insulation part 61, the positioning tolerance of the sensor 91 can be absorbed as the temperature distribution is averaged with respect to the longitudinal direction of the flavor inhaler 100, and ease of assembly of the atomization unit 30 can be improved.

Note that the first heat insulation part 61 may include radiation suppression material. Specifically, when manufacturing the sheet-like insulation member 64, the fibreglass sheet may be coated with aerogel ink mixed with radiation suppression material and dried. Preferably, the radiation suppression material includes at least one of the group consisting of silicon material, metal oxide, carbon material and metal material. This may cause the radiation suppression material to have an opaque nature (for example, a transmittance of 80% or less) for infrared to far infrared electromagnetic waves. Therefore, the radiation suppression material may absorb, reflect, or scatter electromagnetic waves, such as infrared or far infrared, generated from the high-temperature heating part 40, and prevent the exterior of the device from being heated by electromagnetic waves.

Also, preferably the radiation suppression material includes at least one of the group consisting of SiC (silicon carbide), SiO2 (silicon oxide), TiO₂ (titanium oxide), and hydrophobic carbon. These materials have low water absorption, so the energy consumed by heating or evaporating moisture held by the radiation suppression material is reduced. Therefore the decrease in the heat insulating performance and the increase in the heat capacity of the first heat insulation part 61 are reduced, and the energy loss due to the first heat insulation part 61 can be reduced. Also, if the radiation suppression material is selected from at least one of the above groups, the radiation suppression material is insulating, so a short circuit can be prevented from occurring if the radiation suppression material falls out of the first heat insulation part 61 and enters the electrical control unit of the flavor inhaler 100. The thermal insulation function of the atomization unit 30 can be improved because the first heat insulation part 61 includes the radiation suppression material, which can reduce thermal radiation to the outside of the chamber 50.

The radiation suppression material may also be sheet-like and arranged between the layers of the first heat insulation part 61. FIG. 7 is an enlarged cross-sectional view extracted from the heat insulation part 32 shown in FIG. 4. As shown in FIG. 7, a sheet-like radiation suppression material 92 is arranged between the layers of the first heat insulation part 61. Here, the radiation suppression material 92 is preferably arranged on the outer surface of the innermost layer of the first heat insulation part 61.

In this way, by arranging the sheet-like radiation suppression material 92 between the layers of the first heat insulation part 61, thermal radiation to the outside of the chamber 50 can be reduced, thereby improving the heat insulating function of the atomization unit 30. Also, by arranging the sheet-like radiation suppression material 92 on the outer surface of the innermost layer of the first heat insulation part 61, that is at a position close to the chamber 50, thermal radiation to the outside of the chamber 50 can be efficiently reduced.

The first heat insulation part 61 may also have a heat diffusion member 93 arranged between the layers of the first heat insulation part 61 and extending along the longitudinal direction of the flavor inhaler 100. FIG. 8 is an enlarged cross-sectional view extracted from the heat insulation part 32 shown in FIG. 4. As shown in FIG. 8, the heat diffusion member 93 is arranged between the layers of the first heat insulation part 61. Here, a plurality of heat diffusion members 93 may be arranged. By arranging the heat diffusion members 93 extending along the longitudinal direction of the flavor inhaler 100 between the layers of the first heat insulation part 61, the heat diffusion members 93 diffuse heat in the longitudinal direction of the flavor inhaler 100, which can prevent local high temperatures in the first heat insulation part 61.

The heat insulation part 32 may also have a second heat insulation part 65 arranged on the outer circumference of the first heat insulation part 61, having less heat resistance and more thermal insulation than the first heat insulation part 61. FIG. 9 is an enlarged cross-sectional view extracted from the heat insulation portion 32 shown in FIG. 4. As shown in FIG. 9, the second heat insulation part 65 is arranged on the outer circumference of the first heat insulation part 61.

Here, the second heat insulation part 65 is composed of a material such as, for example, a melamine resin foam that carries aerogel inside its foam structure and that has lower heat resistance and higher thermal insulation properties than the sheet-like insulation member 64, which is a glass fiber sheet that includes aerogel particles and which constitutes the first heat insulation part 61. The melamine resin foam carrying the aerogel inside the foam structure has for example a heat resistance temperature of about 240° C. and a thermal conductivity of about 16 mW/mK. By arranging a material that is less heat resistant and cannot be placed in direct contact with the chamber 50 and/or the heating unit 40 but that is more thermally insulating than the sheet-like insulation member 64 around the outer circumference of the first heat insulation part 61 as the second heat insulation part 65, the thermal insulating function of the atomization unit 30 can be improved.

While embodiments of the present invention have been described above, the embodiments of the invention described above are for ease of understanding of the invention and do not limit the invention. The present invention may be modified and improved without departing from its intent, and the present invention includes equivalents thereof. Also, it is possible to combine or omit each of the constituent elements described in the claims and the specification, within the scope of being able to solve at least a part of the problems described above or to achieve at least a part of the effects.

### REFERENCE SIGNS LIST

20: Power source unit
21: Power source
28: Bluetooth (registered trademark) interface
30: Atomization unit
32: Heat insulation part
34: Insertion guide member
40: Heating part
50: Chamber (accommodation part)
61: First heat insulation part
62: Sealing portion
63: Fixing portion
64: Sheet-like insulation member
65: Second heat insulation part
66: Bevelled portion
70: Heat diffusion sleeve
80: Control unit
82: Board
91: Sensor
92: Radiation suppression material
93: Heat diffusion member
100: Flavor inhaler
102: Housing
104: Upper housing
106: Lower housing
108: Sliding cover
110: Aperture
120: Consumable material

1. A flavor inhaler, comprising:
a cylindrical accommodation part that accommodates a consumable material;
a heating part for heating the consumable material accommodated in the accommodation part;
a first heat insulation part arranged to cover at least a portion of the accommodation part to reduce heat dissipation to the outside of the accommodation part; and
a housing that accommodates the accommodation part, the heating part, and the first heat insulation part, wherein
the first heat insulation part has a multi-layer structure in which a heat-resistant sheet-like insulation member is wound in multiple layers around the cylindrical portion of the accommodation part,
an innermost surface of the first heat insulation part is in contact with the accommodation part and/or the heating part, and
an outermost surface of the first heat insulation part is separated from the inner surface of the housing.

2. The flavor inhaler as claimed in claim 1, wherein
the first heat insulation part comprises one sheet-like insulation member.

3. The flavor inhaler as claimed in claim 1,
wherein
the thickness of the sheet-like insulation member is one mm or less.

4. The flavor inhaler as claimed in claim 1, wherein
the first heat insulation part has a multi-layer structure in which the sheet-like insulation member is wound in three to seven layers.

5. The flavor inhaler as claimed in claim 1, wherein
the first heat insulation part comprises a radiation suppression material.

6. The flavor inhaler as claimed in claim 5, wherein
the radiation suppression material is sheet-like and arranged between layers of the first heat insulation part.

7. The flavor inhaler as claimed in claim 6, wherein
the radiation suppression material is arranged on an outer surface of the innermost layer of the first heat insulation part.

8. The flavor inhaler as claimed in claim 1, further comprising
a heat diffusion member arranged between layers of the first heat insulation part and extending in the longitudinal direction of the flavor inhaler.

9. The flavor inhaler as claimed in claim 1, further comprising
sealing portions covering both ends of the first heat insulation part in the longitudinal direction of the flavor inhaler.

10. The flavor inhaler as claimed in claim 9, further comprising
a fixing portion securing the first heat insulation part and the sealing portions.

11. The flavor inhaler as claimed in claim 1, wherein
the first heat insulation part has a major diameter and a minor diameter in a cross section perpendicular to the longitudinal direction of the flavor inhaler, and further comprising a control unit arranged adjacent to the accommodation part in the direction of the minor diameter.

12. The flavor inhaler as claimed in claim 1, further comprising
a sensor for measuring the temperature of the accommodation part, arranged between layers of the first heat insulation part.

13. The flavor inhaler as claimed in claim 1, further comprising
a second heat insulation part having lower heat resistance and higher thermal insulation than the first heat insulation part, arranged on the outer circumference of the first heat insulation part.

14. A method for manufacturing a flavor inhaler, comprising:
a step of preparing a cylindrical accommodation part for accommodating a consumable material; and
a step of wrapping one heat-resistant sheet-like insulation member in multiple layers around the cylindrical portion of the accommodation part.

15. The method of manufacturing a flavor inhaler as claimed in claim 14,
wherein
the thickness of the sheet-like insulation member is one mm or less.
